(19) United States
(12) Patent Application Publication
(10) Pub. No.: US 2007/0293212 A1
(43) Pub. Date: Dec. 20, 2007

(54) SYSTEM AND METHODS FOR USING ONLINE COMMUNITY IDENTITIES OF USERS TO ESTABLISH MOBILE COMMUNICATION SESSIONS

(75) Inventors: Colin Shong Chin Quon, Vancouver (CA); Jeff A. LaPorte, Vancouver (CA)

Correspondence Address: KNOBBE MARTENS OLSON & BEAR LLP, 2040 MAIN STREET, FOURTEENTH FLOOR, IRVINE, CA, 92614, US

(73) Assignee: NELTURA TECHNOLOGY, INC., Richmond (CA)

(21) Appl. No.: 11/764,092

(22) Filed: Jun. 15, 2007

Related U.S. Application Data
(60) Provisional application No. 60/814,150, filed on Jun. 16, 2006.

(51) Int. Cl. H04M 3/00

(52) U.S. Cl. 455/420

(57) ABSTRACT

A system is disclosed that provides functionality for two users to establish multi-modal communication services including voice, messaging, and instance messaging on mobile devices using one or more online community identities. Based on the online identity and profile of a first user of on an online community, a second user may initiate a communications session request to the first user. A service bridging server may incorporate the profile and other information such as presence status of the second user into the session request message and then send the session request to the mobile client of the first user. The first user can act on the session request with a range of disposition options and multiple modes of communication types on the first user mobile device based on the online community identity of the first user and the second user.

### CROSS-REFERENCE TO RELATED APPLICATIONS

This application claims the benefit of U.S. Provisional Patent Application No. 60/814,150, filed Jun. 16, 2006, the entire disclosure of which is hereby incorporated by reference.

### BACKGROUND OF THE INVENTION

1. Field of the Invention

This disclosure relates generally to the field of mobile communications, and more particularly, relates to the use of a user's identity in an online community to establish a mobile communication session.

2. Description of the Related Art

Typically, person-to-person interaction, such as dating, starts with an intent and some context and then progresses through a number of stages towards live communications, and then, face-to-face meetings. Presently, a number of communications tools can be used for a caller to signal to a callee the communications intent. For example, communications tools that support disposable identities such as instant messaging (synchronous and requiring both parties to be on a buddy list) and email (asynchronous and deliverable to any valid email address) can be used to signal caller intent such as “can we talk”. With disposable identities, a user can create multiple identity aliases for different purposes such as dating, business, and communicating with friends, and can discard such identities without incurring significant inconvenience or cost. Similarly, other communications tools with less disposable identities such as SMS (asynchronous where the callee does not have to answer), voice mail (asynchronous where the caller did not answer), and voice phone call (synchronous where the callee has to answer) can also be used by the caller to communicate intent or expression of interest in communicating with the callee.

Existing communications tools typically tie the identity interaction to the identity of the communications service. Suppose Joe on MySpace (or eBay or another community) has a service identity Jack on Skype (or Google or AOL or another communications services backplane) and that Jane on MySpace similarly has an identity Janice on Skype. If Joe clicks on Jane in MySpace, they can communicate through the backplane via their Skype identities as Jack to Janice, or they would have to create a new alias in Skype as Joe' and Jane'. In either case, it would be Jack or Joe' that is communicating with Janice or Jane+ and not Joe communicating with Jane.

EQO Communications launched a service that extends online identities and communications to mobile devices and across disassociated networks in February 2006. The initial launch application links Skype identities and services onto J2ME-equipped mobile devices on mobile carrier networks. The solution retains the original caller Skype identity where Skype is federated with the PSTN via SkypeOut but it does not specifically separate the calling identity such as eBay or MySpace caller identity from the Skype communications identity due to underlying limitations of the Skype network.

A number of companies, including Tello, are pushing IM and communications federation technology that allows users on one domain such as MSN to communicate with users on another domain such as Yahoo. Services such as GoogleTalk provide an open communications infrastructure such as Jabber/XMPP for presence and contact list interfacing and libjingle for call signaling and control. Such technology allows web 2.0 type solutions enabling applications to leverage GoogleTalk as a communications backplane.

Both Skype and Google have deployed Click-to-call functionality wherein a hyperlink on a web page can be clicked to initiate a call to a particular ID. In these applications, the called user's identity on the communications network is exposed to the caller, and the calling user's ID is exposed to the called user. Computer-Telephony Integration (CTI) technology has been deployed which can initiate calls from a computer application, typically from a contact management application such as Microsoft Outlook.

A number of click-to-call services exist today, such as Jajah and SkypeMe. Since the filing of U.S. Provisional Patent Application No. 60/814,150, filed Jun. 16, 2006, referenced above, other players such as Jangl and Jaxtr have started services that allow users to expose clickable links to initiate communications sessions. For Jajah, it is envisioned that a user can click on a phone number which is represented as a callable URL, and a call is then made between the callable URL and the user's phone. For SkypeMe, a user with the Skype PC client can click on another user's SkypeMe button, and a call is then made between the caller and the callee on the Skype network.

### SUMMARY

The disclosed system, methods, and devices each have several aspects, no single one of which is solely responsible for its desirable attributes. Without limiting the scope of this invention, several of their features will now be discussed briefly.

In one embodiment, a method of establishing multi-modal communications between a first user and a second user using online community identities is provided. The first and second users may each have an online community identity and an online community profile. The method includes providing the first user with an interface element for inviting contact from the second user; displaying the interface element to the second user; receiving an indication from a communications device of the second user of a desire to initiate a communication session with the first user; creating a session request message in response to the indication, the session request message including data related to the online community profile of the second user; sending through a first network the session request message to a mobile client on a mobile device of the first user; receiving an indication that the first user has accepted the session request; establishing a first session leg with the mobile device of the first user through a second network; establishing a second session leg with the communications device of the second user through a third network; and bridging the session legs between the first user and second user to create the request communication session.

Another embodiment of the present disclosure may be found in EQO Mobile, a mobile phone service from EQO, the assignee of the present disclosure, that enables users to make global calls at some of the lowest international rates available, send global text messages, and chat using all the major Instant Messaging clients such as MSN Messenger, GoogleTalk, Yahoo, AIM, and ICQ. The EQO service provides a free downloadable mobile software application that is easy to install, and as simple to use as a standard phone address book. The EQO member-to-EQO member voice calling service allows voice calls between any EQO users of the service as local dial access calls or free VoIP calls. The EQO Out voice calling service allows EQO users to call any phone number similar to SkypeOut but from mass market mobile phones. The EQO service also supports EQO-to-EQO multimedia messaging, EQO Out text messaging, and premium services such as click-to-conference, dynamic call disposition such as redirect to alternate number or voice mail, directory services etc.

Specific embodiments are disclosed of systems and methods for extending online identities and communities across disassociated networks and through various communication backplanes, and allowing the services to be consumed on a mobile device. For example, in one embodiment, the service can be extended to other end user devices and services such as PCs, TVs set-top boxes or gaming consoles. Moreover, disclosed advantages and benefits can apply to only some embodiments of the invention, and should not used to limit the invention.

In another aspect, a method is provided to allow two users to initiate communications with each other through original caller and callee identities through multi-modal communications services and alternative communications backplanes. The method may also provide a capability for a user to publish or send a session invitation handle which allows users to interact with rich context using online identities and through multi-modal communications services, such as messaging, IM chat, and voice.

In another embodiment, a system provides dynamic and context-driven call control technology (called a nudge) that decouples the call request (which is analogous to a tap on the shoulder) from the actual call and call path such that the original calling identities are used for call initiation, call acceptance, and call routing. A number of methods are available to alias the caller identities or retain the original caller identities, and then statically or dynamically route the actual call and multimedia session between the participating calling parties.

In still another embodiment, the nudge technology may be used to not only enable dynamic call disposition but also to allow the initiating call nudge to be initiated with caller context such as, who the caller is, why the caller is calling, the importance of the call, the context of the call, and other related information, such as the call referring party; and also enables such context and intent to be published or pushed as session request nudge message.

In accordance with an embodiment of the invention, a user “A” with one or more service identities, such as “a”, can publish or send communications session nudge invites to user “B” with service identity “b” which can progress through various session permissions stages and then communicate through a number modes comprising message, SMS, IM chat, and voice. The service identity “a” can be any identity which user “A” has exposed to user or users “B”. A particularly useful scenario occurs when service identity “a” is a service identity that is defined within an online community, such as MySpace.

Another embodiment of the invention allows user “A” to initiate a session request to user “B” and provides user “B” with user “A's” profile, call context, call options such as “IM chat”, and “voice call”, and a number of dynamic or statically configured session disposition options comprising “accept”, “reject”, “queue”, and “redirect”. Based on the disposition option selected by user “B”, a session with media is then initiated from user “A” with service identity “a” via a communication service with identity such as “aa” to user “B” with service identity “b” via a communication service with identity such as “bb”.

The session identities “aa” and “bb” may be re-aliased back to the original user service identity “a” and “b” via a centralized gateway. Alternatively, if user “B” with service identity “b” accepts a session from user “A” with service identity “a”, the centralize gateway initiates a session to user “A” on communications service identity “aa” and also to user “B” on communications service identity “bb” in such a way that the sessions appear to be associated with service identities “a” for user “A” and service identities “b” for user “B”.

The solution as described in an embodiment of this invention also has user clients that can be deployed in a myriad of configurations comprising mobile phone, PC client, and software objects that can be integrated with messaging clients such as MSN and Yahoo or ICQ messenger, or embedded on IP appliances. One aspect provides a number of possible applications such as transient-mode spontaneous communications where two users without knowing each other's service identity such as telephone number can engage in communications. Further, users can communicate using the identity of the online community, and can do so with rich context such as the profile of the users and the intent of the communications session. It also helps to keep the user's communications services such as phone numbers anonymous thereby protecting the user's privacy and eliminating the exchange of less-disposable identities. End users can dynamically choose to accept, reject, queue, and otherwise dispose the communications request and can dynamically switch communications modes such as messaging, IM chat, and voice. It allows users to separate the call intent from the actual communications tool used for the actual communications session.

The invention thus comprises, among other things, a system for facilitating the establishment of voice calls between mobile device users. The system comprises a first system that hosts an online community in which users have online community identities. The system further comprises a second system that communicates with the first system to allow mobile device users that have both mobile device identities and online community identities to establish voice calls between their respective mobile devices using their respective online community identities, without exposing their respective mobile device identities to each other.

Neither this summary nor the following detailed description purports to define the invention. The invention is defined only by the claims.

### BRIEF DESCRIPTION OF THE DRAWINGS

FIG. 1 shows one embodiment of the application service system architecture context.

FIG. 2 shows examples of one embodiment of service application use case scenario and context.

FIG. 3 shows a flow diagram of first user initiating communications session request from an online community to mobile client of second user, and setup of a voice communications session between the first user and second user.

FIG. 4 is a flow chart of a process for providing multi-modal communications.

### DETAILED DESCRIPTION OF THE SPECIFIC EMBODIMENTS

The following description is intended to illustrate specific embodiments and features of the invention, and is not intended to limit the scope of the invention.

Numerous deficiencies exist in existing communication service applications. For example, the communication tools described above do not support transient short-lived communications sessions that allow users to easily exchange interaction context without revealing significant personal information, such as a personal mobile phone number. Further, technologies such as Tello and GoogleTalk do not allow users on different communities to communicate via the original caller identities or express caller intent and calling context that is available via the call nudge technology. In addition, in the existing CTI applications described above, there is no bridging of services, and there is no concept of initiating a communications session via indication on one service, while providing the communications service via another service using a different identity which remains protected.

Moreover, click-to-call services such as Jajah and SkypeMe have a number of limitations. In the case of Jajah, the callee number is typically exposed, and there is no way to convey caller intention or the ability to use an online calling identity. For SkypeMe, both parties have to be Skype users, and the callee whom exposes the SkypeMe button has to enable any Skype users to call them, even those not on his or her Skype buddy list. Further, there is no call request context and calls between two Skype users is based on the identity of the Skype service.

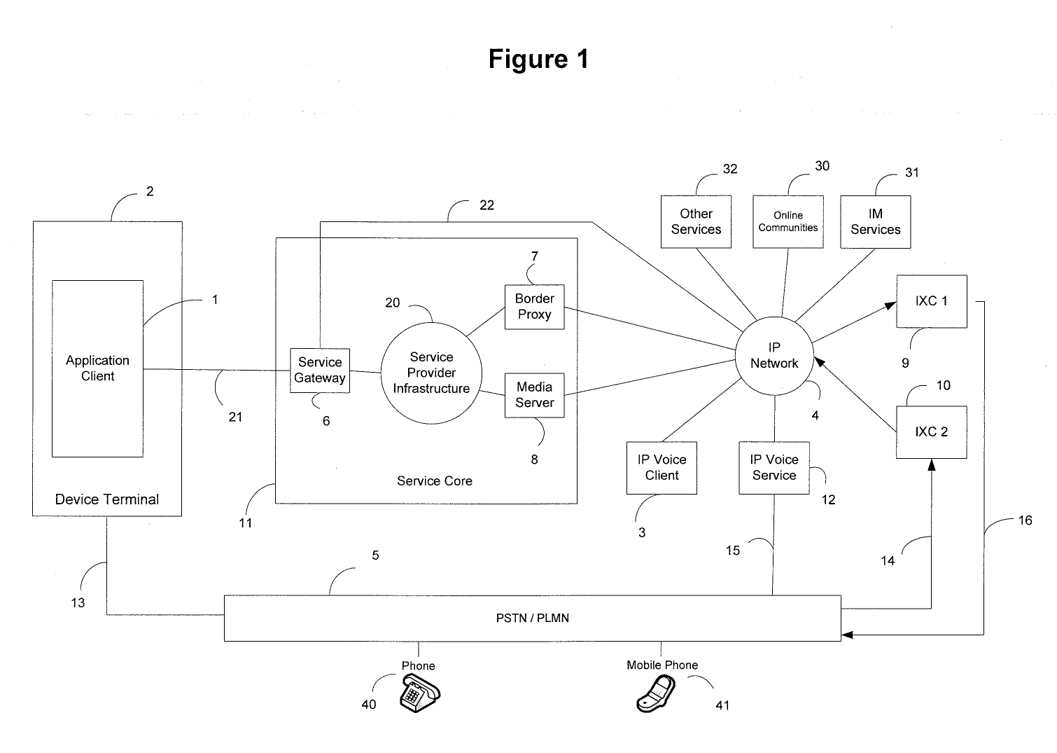

An embodiment of the disclosed system and services is depicted in FIG. 1. As shown in FIG. 1, the system comprises an application client 1 hosted on a variety of device terminals 2, some or all of which may take the form of a mobile device. The application client 1 (which may be a mobile application client if run on a mobile device) may be provided as a free download, and may further be adapted to run on a range of application platforms including J2ME, WindowsMobile, Blackberry OS, Symbian, and Palm. The device terminal 2 preferably is capable of voice services through mobile network interface 13 and data services through network interface 21 on service networks such as GSM/GPRS/EDGE, UMTS, CDMA, WiFi, and WiMAX. (Reference number 21 in FIG. 1 corresponds both to the wireless data network itself, and to the mobile device's terminal's interface to that network. Similarly, reference number 13 corresponds generally to both the mobile network itself and to the mobile device terminal's interface to the mobile network.) The application client 1 may include all of the functionality of the mobile client described in U.S. patent application Ser. No. 11/428,283, filed on Jun. 30, 2006, the disclosure of which is hereby incorporated by reference in its entirety.

As illustrated in FIG. 1, the application client 1 uses the mobile device terminal's wireless data interface 21 as a signaling interface for communicating with the service gateway 6. The wireless data interface/network 21 is preferably an IP (Internet Protocol) transport network. The application client 1 is also capable of using the mobile device terminal's mobile interface/network 13 (which ordinarily is not an IP network) to establish voice media connections (voice calls) and to provide other types of voice services.

In another embodiment, the application client 1 and the VoIP media client 3 can be on the same device terminal 2. For example, the device terminal 2 may have a native SIP VoIP client, as is the case with some existing dual mode phones. If present, the native SIP VoIP client can preferably be controlled by the service gateway 6 through SIP signaling.

The application client 1 also provides a user interface for handling various tasks such as a contact list management, messaging, and instant messaging. The application client 1 processes events such as call request, presence status, messaging, and contact synchronization events, based on the digital signals received over the interface 21. As one example, the service gateway 6 may push contact presence information to the application client 1, which may display this information in a visual display of the device terminal's contact list. The application client 1 also transmits client and user event information over the wireless data network 21 to the service gateway 6. The application client 1 has access to the voice and data services on the device terminal 2 through its internal device application programming interfaces (API).

The service core 11 may include a service gateway 6, a service provider infrastructure 20, and a signaling proxy 7 (also referred to as a border proxy) and media resource 8 (also referred to as a media server). The service gateway 6 may include all of the functionality of the service gateway described in application Ser. No. 11/428,283, mentioned above. The service gateway 6 is an application server that provides signaling control and service bridging functions between the application client 1 and external service networks such as the PSTN 5 and IP voice service network 12 such as GoogleTalk and Vonage. The service gateway 6 may also provide other service bridging functions via an interface 22 to IM services networks 31 such as MSN, Yahoo, AIM, and QQ for example, and online communities 30 such as Myspace and Facebook, and other services 32 such as Skype and Short Messaging Service (SMS) interconnect. The interface 22 may be implemented as one or more service proxies or possibly as a plug-in client (as in the case of Skype). The interface typically is implemented over an IP transport network. As discussed in additional detail below, the service core 11 typically includes multiple service gateways 6, and the application clients 1 are typically capable of selecting between some or all of these service gateways 6.

The service provider infrastructure 20 in the service core 11 provides various service functions such as a subscriber service database, a contact list and presence server, accounting and billing mediation, prepaid service, service payment web services, SIP registrar and redirect servers, web servers for service fulfillment and/or user provisioning, and network management as well as other operational and business support systems. The various components of the service core 11, such as the presence, media server, redirect, border proxy, and AAA functions, may be embodied in respective code modules executed by one or more general purpose computers.

For voice service, at the signaling layer, the service gateway 6 and service provider infrastructure 20 interface to the public switched telephone network (PSTN) 5 through the signaling border proxy 7, which preferably uses SIP as the signaling protocol. The border proxy 7 may interface to a number of voice origination providers or inter-exchange carriers (IXC 2) 10, and a number of voice termination providers or inter-exchange carriers (IXC 1) 9 through IP network 4. The border proxy 7 may also interface to IP voice services 12 and IP voice clients 3 through the network 4. At the media layer, the media server 8 bridges one or multi-party voice media from voice origination network 10 and voice termination network 9, as well as IP voice services network 12 and IP voice clients 3. The media server is not always required and may only be used during certain phases of the call setup such as tones, announcements, conferencing, and voicemail. Preferably, the media server 8 interfaces with voice origination network 10, voice termination network 9, IP voice service network 12 and IP voice client 3 using Real Time Protocol (RTP). All the call legs traversing the Service can be homed to a single media server 8 but can also be re-homed to another media server 8 through mechanisms such as multi-stage SIP INVITE. In addition, the call legs can be distributed and bridged through multiple geographically distributed media servers 8. For redundancy and scalability, there can be multiple instances of the media server 8 that can be accessed via DNS SRV and can also be physically distributed geographically across multiple data centers.

In one embodiment of the system as shown in FIG. 1, the application client 1 can programmatically cause the mobile device 2 to connect to a telephone network service 13 to the PSTN 5 or IP voice Service network 12. In a variant of this design, the application client integrate via a SIP user interface 4 to one or more inter-exchange carrier networks 9, 10 that can bridge the call to the traditional telephone network 5. The signaling interface 21 may be TCP-based and may use a protocol encoding and scheme that minimizes battery usage and bandwidth on the device terminal 2. If device terminal 2 cannot support TCP or users with service plans that do not support TCP transport, alternate transport methods such as HTTP may be used for the interface 21. The exchange of information between the application client 1 and the service gateway 6 over interface 21 can use a number of encryption schemes such as AES, and may use authentication schemes such as kerberos and HTTP digest depending on device and network requirements.

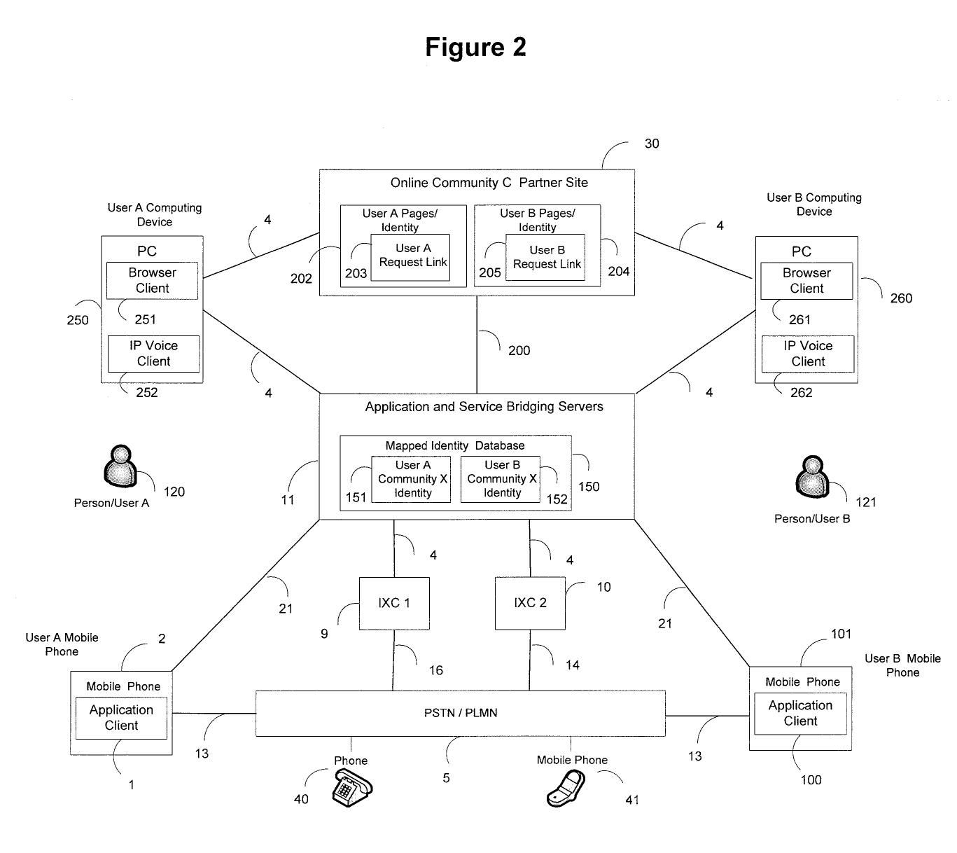

In accordance with an embodiment of the invention, a set of functional elements such as, for example, the service gateway 6 with mapped identity database 150 and application client 1 on device terminal 2, are integrated into an existing telecommunications network and the Internet to provide the identity aliasing and session invitation features. As used herein, “Contact Me” refers to one embodiment of a communications session request link or interface element that a first user can publish or push to a second user. Further, “identity aliasing” refers to a first user using the service identity of an online community to establish communications with a second user on the same online community from their respective mobile devices without changing the identity context or revealing their mobile service identities. An embodiment of the “Contact Me” and “identity aliasing” features is shown in FIG. 2 and certain aspects of the embodiment are illustrated herein in two use case scenarios.

In one such use case scenario, user A 120 publishes a “Contact Me” link 203 such as a button or a widget on a web site 30. The web site may be, for example, a dating site or another type of online community site (e.g., MySpace). User B 121 on a computing device 260 with browser 261 may view user A's web pages 202 on the online community 30. The “Contact Me” link 203 of user A 120 may be visible to user B 121. The visibility of the link to user B may be conditioned on user B 121 meeting specific profile filters (such as gender, geographical location, marital status, and having photo image) set by user A 120 via special pages of the web site 30. The “Contact Me” link 203 of user A 120 may also be shown with other information such as user A's presence, meta-location information, and other context information that user A 120 may selectively and controllably expose to user B 121. If user B clicks on user A's “Contact Me” link 203, the bridging service core 11 may translate this action into a communications session request and send this request to the mobile application client 1 on user A's mobile device 2. As part of this process, the service bridging application core 11 may extract/retrieve user B's profile 204 from the community web site using an API (Application Program Interface) 200 or another type of interface, and may send this profile information to user A's mobile device with the service communications session request. The API 200 or other interface may also extract additional information such as such as presence status, session context, and other session disposition options such as “accept”, “reject”, and “voice mail” as well as service options such as messaging, IM, and voice via interface 21 and transmit the information to user A's mobile client 1 on user device 2.

To implement the foregoing functionality in one embodiment, the operator of the online community web site 30 configures one or more servers of this web site 30 to accept API calls from the service core 11. The API calls may be sent using REST, SOAP (Simple Object Access Protocol), JSON (JavaScript Object Notation), or XML/RPC. For example, in one implementation, the API is based on REST with API functions such as “getProfile” and “submitVote,” and with custom XML responses. The response to the “getProfile” API call includes all or a portion of specified user's online community profile (as posted on the relevant community web site 30), which may be returned in a pre-specified format. Each user may be able to specify, via web pages of the online community site 30, the particular types of profile information to be exposed via this API.

In another embodiment, instead of using an API, a browser plug-in may be provided that is capable of scraping the user profile data a web page of the community site 30, and forwarding this data to the service core 11. The plug-in may also be capable of rendering a “Contact Me” display element on the community site. For community sites that allow for the pasting of third party widgets, the Contact Me display element may alternatively be added to the page coding as a widget. This widget may include a field for entry of user data, or may serve as a link to another page for entering such data.

With further reference to FIG. 2, user A 120 may accept the session request on the mobile client 1 on user device 2. If so, the session response is sent from the mobile client 1 via interface 21 to the service core 11 which then sets up the call legs between user A's user device 2 via the PSTN 5 and the voice origination or termination providers 9,10. The service core 11 may also set up the call leg between user B's user device 101 via the PSTN 5 and the voice origination or termination providers 9,10. The service core 11 then bridges the voice session to establish end-to-end voice media between user A's user device 2 and user B's user device 101. The session setup may be completed using the online identities of user A 202 and user B 204 without the need to reveal the service identities such as mobile phone number of user A's device 2 and user B's device 101. Note that for convergence devices, computing device 250 and mobile device 2 may be the same terminal device, and the mobile client 1 and browser 251 can reside on the same converged terminal device used by user A 120. For such a converged service device such as one with a SIP VoIP client, the communications media may be established directly as VoIP media between the IP voice client 252 of user A device and the service core 11.

In another exemplary embodiment, user A 120 may find user B 121 on an online community site 30 and may wish to communicate with user B 121. User A may use a browser 251 on a computing device 250 or a mobile client 1 on mobile device 2 to request that the service bridging core 11 push a “Contact Me” message with a communications session request link 203 to user B's mobile client 100 on device 101. The service core 11 may use the interface 200 to extract user A's profile 202 and send such profile information along with the “Contact Me” session request link to user B's mobile client 100 on device 101 via interface 21.

Upon receipt of the “Contact Me” push message, user B 121 may open the message on the mobile client 100 of user device 101. This message may include some or all of the following types of user profile information extracted/retrieved via the API or other interface: name, profile, location, presence status, picture image. Upon viewing this message, user B may decide whether or not to accept the communications session request from user A. In one embodiment, if the session request is a voice call, the service core 11 may set up a call between user A's device 2 and user B's device 101 using the online community 30 identity context 202 of user A and online community 30 identity context 204 of user B without revealing the identity (e.g. mobile phone number) of user A's communications device 2 and user B's communications device 101. This type of identity aliasing may also be applied for other session types including messaging or instant messaging, or in the context of meta service objects such as an electronic “flower” or e-card.

In one embodiment, user B 121 may accept the communications request from A 120 but choose not to initiate the actual communications session. In such a case, the “accept” response from user B 121 may be routed by the service bridging core 11 back to user A 120 who may then initiate communications with user B 121 via a number of communications options such as messaging, IM chat, and voice. These communication option may be selected (or preselected) as a preference set by user B 121. As noted previously, computing device 260 and mobile device 101 may be the same terminal device, and the mobile client 100 and browser 261 can reside on the same converged terminal device used by user B 121.

The following sections now outline the system architecture context. The call signaling associated with a “Contact Me” session request can be asynchronous or synchronous. That is, a session request initiated by the caller may be delivered to the callee in either online or offline mode. In some embodiments, the session request message itself can have a time-to-live period in which communications intent is valid between the callers and callees. The online community 30 usually takes the form of a set of web application servers, application databases, and user account databases. This element provides service to the user via a web browser 251,261 connected to the online community 30 via the IP network 4 (which may be the Internet). The online community 30 client application typically includes a user interface. The user interface may be graphical or text based. In many cases, the online community application includes an HTML document-based interface provided for display on a web browser. The user interface can take other forms as well, such as Flash, Shockwave, DHTML/AJAX or other rich-content based user interface technology. The user interface generally has the ability to display text or graphics to a first user 120, the viewer, representing the identity of a second user 204. Further, the user interface for the online community 30 provides an ability for mechanism for the user A 120 to signal their intent to communicate with the user B 121; this mechanism, for example, can take the form of a selectable hyperlink.

The mapped identity database 150 with identity profile 151 for user A 120 and identity profile 152 for user B 121 includes a database which stores the mapping of Online Community identities to Bridged Communications Network identities. This database can take several forms. Examples of typical forms of the database include: (a) a relational database management system, (b) an object-relational database management system, (c) an XML document database, and (d) a DNS-based database such as ENUM, or some combination or the three. The interface to this database can likewise take several forms. A SQL-based query interface, XPath/XQuery-based query interface, or Web Services-based interface to the Mapped Identity Database would be typical.

A User Identity is a unique identifier “a” 202 for a user A 120 within a particular network or community 30. The identifier 202 can be made globally unique by creating a related identifier “c-a” by concatenating a unique identifier for the community “c” 30 and the original identifier “a”. A User Identity Profile for a user A 120 with User Identity “a” 202 is the set of user attributes and descriptive data within the particular network or online community 30 hosting identity “a”. This profile typically includes one or more pictures of the user, and a text description readable by other members of the community. Another common attribute is a feedback measure defined by the accumulated set of feedback provided by other community members. For example, other community members can provide their rating of user A's 120 friendliness. In this case, the feedback measure can be calculated as a simple average of the contributed ratings. Many other methods of calculation can be useful. Many other types of user attributes can also be included in the User Identity Profile.

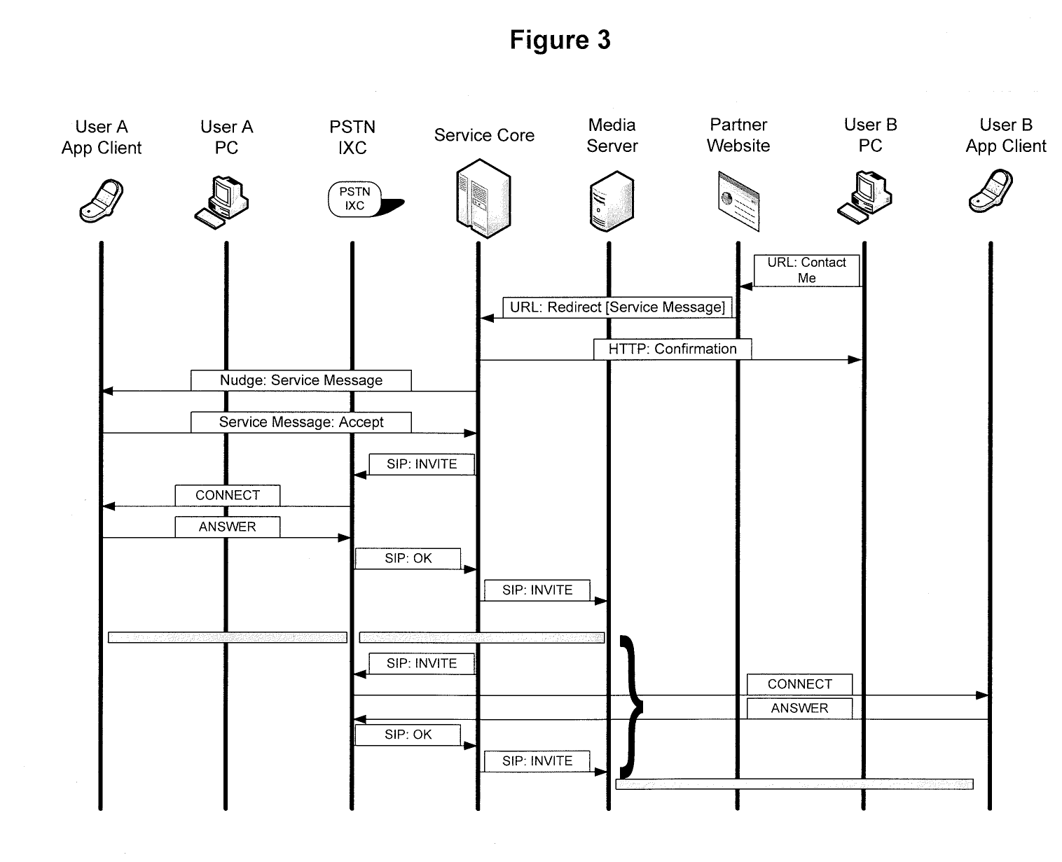

FIG. 3 provides an example of the data flow which occurs during an interaction between user B 121 and user A 120 via an online community 30. In the example provided, user B 121 views the profile of user A 120 on an online community 30 and clicks on the “Contact Me” link 203 of user A. In response to the click, an HTTP message is sent to the service core 11, and the service core 11 propagates a session request to the mobile client 1 on device 2 of user A. If user A accepts, the process of setting up a voice communications session between the mobile device 2 of user A 120 and the mobile device 101 of user B 121 proceeds as shown in the diagram.

In this particular session flow example, user B 121 may be taken to an “Contact Me” message entry page. User B's profile 204 on the online community 30 may be extracted by the service bridging application core 11 via API 200. The service core bridging application 11 may then send the session request message to user A's mobile client 1 on mobile device 2. In this particular example, user A accepts the session request as a voice call and the service bridging application core 11 initiates a call back via a voice termination provider 10 to user A's mobile device 2 via the PSTN 5. Once user A answers the call, the service bridging application core 11 initiates a second voice termination call leg via the voice termination provider 10 to user B's 121 mobile device 101. When user B 121 answers the call on device 101, an end-to-end voice path is established between user A 120 by the first call leg and user B 121 by the second call leg, and bridged by the media resource in the service bridging application core 11 media server 8. Instead of a call back flow, other variants of the call flow may be a direct forward dial call from user A's device 2 to an access number on the PSTN and then routed via voice origination provider 9 to the service bridging application core 11.

In another embodiment, various aspects of the service application may be applied within the context of dating or matchmaking communities. This embodiment makes use of the same overall framework with certain additions. The Dating Event is a variant of a communications message. It has an abstract meaning derived from an action metaphor in the dating context. For example: To send someone a (electronic) smile, or to send someone flowers are particular actions in the dating context.

A dating event may include various implicit and explicit attributes: Metaphor-based name, social meaning, social context, social value, operator value. With a “Contact Me” link, a dating event can be appended with explicit, implicit, or hidden communications parameters such as hours which the user can be reached, methods to which the user prefers, cost parameters, and validity period.

The value of a dating event can be understood in two parts: The value to the sending or receiving user, and the value to the community operator. The value provided to the sending user is that by invoking the dating event, the sending user is able to express a social meaning which is derived from the context carried by the dating event by virtue of the real-world action for which the dating event is a metaphor. An example of a dating event may be a “smile” which may be characterized as the sender flirting or expressing an interest to communicate further with the recipient. Where the sender and the recipient do not yet know each other, (with the exception of that which has been exposed to the sender in the recipient's profile), this method enables the sender to minimize cost as well as impact to self-esteem if the desire for contact is not reciprocated by the recipient.

Another embodiment involves sending messages such as, for example, the “Contact Me” message over a third party backplane. Third party backplanes may include services such as Skype, Google, MSN, and others. In this specific embodiment, a user A 121 on a computing device such as a mobile phone or PC web browser can publish or send/push an “Contact Me” message to express context and communications session intent and call handles through a backplane such as Skype. The receiving party user B 121 can then click or invoke the “Contact Me” on a computing device through a browser or other software. This allows user to accept the session request or to re-initiate the session request, and append or enter session context. This exchange of session intent can be initially carried through the third party backplane but subsequently carried directly between the interacting parties without necessarily involving the backplane.

For example, user A can send a “Contact Me” call invite via user A's Skype account to user B's Skype account via the Skype IM chat tool. User B can click on the “Contact Me” URL which directs the user to a screen hosted by the service gateway 6 and presents users B with the “Contact Me” session request message from user A. This screen can show profile information and call context information of user A. On this screen, user B can enter or respond with new call context, enter “B” phone number, and the service gateway then send the response back to user “A”. At this point, depending on the caller disposition, the gateway can establish the call between user A and user B or the call can be deferred until user A decides to initiate the call session. When a call session is made and the session media can be phone-to-phone which is independent of the third party backplane such as Skype.

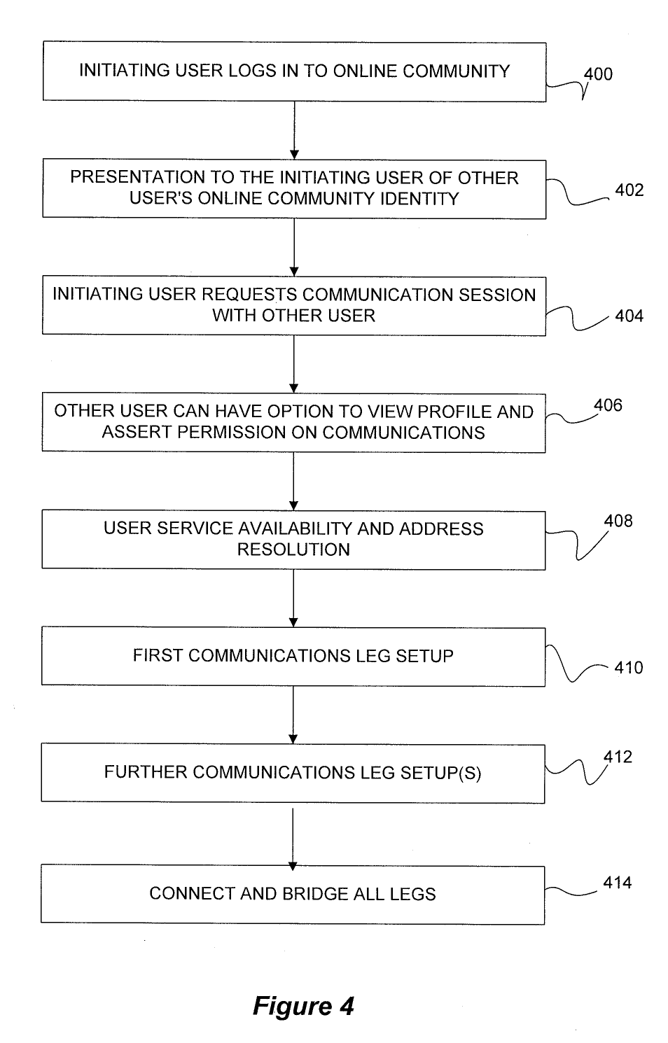

Referring now to FIG. 4, a flow chart showing the various phases the system may execute to provide the services described above is provided. The process begins at block 400 where the Initiating User (such as User B 121, for example) visits the login web page of the Online Community site using the web browser on his/her computing device. The user may execute a login sequence provided by the Online Community 30 to achieve a logged-in state in the web browser. Depending on the particular login functionality implemented by the Online Community, the login process can be automatically executed on behalf of the Initiating User, based on saved username/password data or other form of saved authentication token.

Next at block 402, the Initiating User, User B, possibly after “surfing” through several web pages on the Community Site, arrives at a web page on the Community Site which presents a visual object representing the ability to initiate a communications session with the Other User “A” via the Other User A's Online Community identity. Alternatively, the same object can be pushed or sent from user “A” to user “B” through user B's message inbox, for example. The visual object can take the form of various navigable links such as Hyperlinked text, a hyperlinked button, a hyperlinked image, or an embedded rich object such as a Flash object, ActiveX control, or Java Applet.

The visual object may incorporate an activation mechanism by which the Initiating User can indicate an intent to begin a communications session with the Other User. The activation mechanism can take many forms such as a hyperlink property, a javascript action, or a two step action where for example, highlighting the visual object by using the user interface environment's selection mechanism, then providing activation by softkey. This type of activation mechanism is common on mobile Consumer Computing Devices. In the preferred embodiment, the visual object may be a combination of a hyperlinked image and textual representation of the Other User(s) Online Community identity in an HTML document, and the activation mechanism is the “href” hyperlink attribute of the HTML “img” and “a” tags.

At block 404, the Initiating User indicates his or her intent to begin a communications session with the Other User(s) by making use of the visual object's activation mechanism. The web browser then creates a communication session request. This communication session request is then transmitted to the Bridging Application Core 11. The particular method of transmission of the communication session request can take several forms. For example, the method of transmission may be a communication session request by browser URI handler.

In this transmission method, the activation mechanism is a hyperlink property wherein the target URI's scheme component is one for which a URI handler has been installed as a web browser plug-in. Some typical URI scheme values which can be used are “callto”, “mailto”, “tel”, “sip”, “aim”, “h323”, and “http”. Other schemes can be used. The browser's URI handler mechanism then transfers the URI to the Bridging Application Browser Plug-in which has been registered as the handler for the particular URI scheme in use. The Bridging Application Browser Plug-in then connects to the Bridging Application Core 11, and sends a request containing the Initiating User's Online Community identity, and the Other User's (or Users') Online Community identity, and the type of communications session to be initiated.

The method of transmission may also be a session request by browser MIME-type handler. In this transmission method, the activation mechanism is a hyperlink property wherein the target URI points to a location on a web server which upon being retrieved via HTTP GET, returns content of a particular MIME-type, say “application/vnd.eqo.comm_initiation”, for which a MIME-type handler has been installed as a web browser plug-in. The browser's MIME-type handler mechanism then transfers the content retrieved via the HTTP GET on the target URI to the Bridging Application Browser Plug-in which has been registered as the handler for the particular MIME-type in use. The Bridging Application Browser Plug-in then connects to the Bridging Application Core 11, and sends a request containing the Initiating User's Online Community identity, and the Other User's (or Users') Online Community identity, and the type of communications session to be initiated.

The transmission method may further include the transmission of a communication session request by submission to a web application interface in the Bridging Application Core. In this transmission method, the activation mechanism is a hyperlink property wherein the target URI points to a location on a web server, which is deployed in combination with the Bridging Application Core. The hyperlink, upon being activated, submits the request data via HTTP GET or POST such as GET or POST parameters the Initiating User's Online Community identity, the Other User's (or Users') Online Community identity, and the type of communications session to be initiated. In still another embodiment, the transmission may be a communication session request by forwarding via Online Community Core

In this transmission method, the activation mechanism is a hyperlink property wherein the target URI points to a location on a web server, which is deployed in combination with the Online Community Core. The hyperlink, upon being activated, submits the request data via HTTP GET or POST such as GET or POST parameters the Initiating User's Online Community identity, the Other User's (or Users') Online Community identity, and the type of communications session to be initiated. Once received by the Online Community Core, the request data is forwarded to the Bridging Application Core 11 via an Internet connection technology.

As noted in the transmission method descriptions above, the communication session request typically specifies the type of communications session to be initiated. The set of communications session types comprise at least one of the following: voice, video, email, instant message, SMS, specific voice network Skype, specific voice network Jingle, specific voice network Yahoo, specific voice network AOL, specific voice network MSN, specific instant messaging network Skype, specific instant messaging network XMPP, specific instant messaging network Yahoo, specific instant messaging network AIM/ICQ, specific instant messaging network MSN, virtual communications session type most immersive available, virtual communications session type least immersive available, and virtual communications session type least expensive available. In general, any communications session type which has a clearly defined party or set of parties to which the session initiation is directed can be used in combination with the described system.

At block 406, the other user is provided the option of viewing the initiating user's profile and/or asserting permission on the communications between them. For example, the other user may limit the times that the initiating user may contact them. Alternatively, the other use may limit the communication to a certain medium such as e-mail or text messaging for example. After the other user has defined the contact parameters and permissions, the process moves to block 408 where the system determines the services available to the users and resolves their addresses as described earlier in this specification.

Using Virtual Communications Session Types allows for the Bridging Application Core 11 to choose the best matching communications type based on the best matching communications services available to the participants. For example, say the requested communications session type is “Virtual Communications Session Type: Most Immersive Available”. Given the service availabilities as listed in the table below, the Bridging Application Core would choose “Voice” to satisfy the request for the most immersive communications type available.

| | Initiating User | Other User |
|---|---|---|
| Email | available | available |
| Voice | available | available |
| Video | available | not available |

Next, at block 410, the first communications leg is set up between the Initiating User and the Bridging Application Core 11. This setup can proceed either from the Initiating User to the Bridging Application Core (Edge Originated), or from the Bridging Application Core to the Initiating User (Core Originated). Both of these types of originations are supported in the various embodiments. By supporting both origination types, the service can be tailored to specific telecom markets. For instance, in some markets termination to particular numbers such as mobile phone numbers are tariffed at a high price, paid by the call initiator. However, other constraining factors influence the choice of mechanism as well. For instance, for call sessions initiated from a software client on some mobile devices, technical limitations make edge initiation less desirable. In particular, some mobile devices initiate calls via a software client running on the device, but the software client immediately shuts down in order for the mobile device to successfully complete the call. This is undesirable from a usability point of view, so in this case the Core Originated call initiation can be preferred.

After the first call leg is established, the service bridging core then proceeds to establish the call legs to one or more of the recipient or callee parties at block 412. When the called party accepts the session, the call leg to the callee proceeds to a connected state by connecting and bridging all legs at block 414. If the called party rejects the session, the service bridging application core may cancel the first communications call leg.

The disclosed method for extending communications via online identities to mobile devices may be implemented in certain embodiments according to the disclosure provided in U.S. patent application Ser. No. 11/314,971 titled “DISTRIBUTED SYSTEM FOR CLUSTERING COMMUNICATIONS DEVICES AND SERVICES AVAILABLE TO A USER” and filed on Dec. 20, 2005, U.S. patent application Ser. No. 11/314,745 titled “DISTRIBUTED SYSTEM FOR SHARING OF COMMUNICATION SERVICE RESOURCES BETWEEN DEVICES AND USERS” and filed on Dec. 20, 2005, U.S. patent application Ser. No. 11/428,283 titled “DYNAMIC AND CONTEXT DRIVEN CALL CONTROL AND SERVICE BRIDGING” and filed on Jun. 30, 2006, U.S. Provisional Patent Application No. 60/814,150, titled “ONLINE COMMUNITY AND IDENTITY EXTENSION TO MOBILE DEVICES” filed on Jun. 16, 2006, which is hereby incorporated in by reference in its entirety.

All of the methods and processes described above may be embodied in, and fully automated via, software code modules executed by one or more general purpose computers, and where applicable, by mobile computing devices. The code modules may be stored in any type of computer-readable medium or other computer storage device. Some or all of the methods may alternatively be embodied in specialized computer hardware.

Although this invention has been described in terms of certain embodiments and applications, other embodiments and applications that are apparent to those of ordinary skill in the art, including embodiments which do not provide all of the features and advantages set forth herein, are also within the scope of this invention. Accordingly, the scope of the present invention is intended to be defined only by reference to the following claims.

What is claimed is:

1. A method of establishing mobile communications between a first user and a second user, comprising:
providing the first user with an interface element for inviting contact from the second user;
causing the interface element to be displayed on a mobile device of the second user;
receiving an indication from the second user of a desire to initiate a communication session with the first user, said indication generated using the interface element;
creating a session request message in response to the indication, the session request message including user profile data obtained from an online community profile of the second user;
sending the session request message to a mobile client on a mobile device of the first user;
receiving an indication that the first user has accepted the session request; and
in response to receiving said indication that the first user has accepted the session request, establishing a communication session between the mobile devices of the first and second users.

2. The method of claim 1, further comprising obtaining said user profile data of the second user via an API call to an online community web site.

3. The method of claim 2, wherein the user profile data is displayed on one or more web pages of the community web site.

4. The method of claim 2, wherein the first and second users have respective community identities in on the community web site, and the method comprises using said community identities to establish the communication session.

5. The method of claim 1, wherein the communication session is a telephone call, and is established without exposing a mobile telephone number of either user to the other.

6. The method of claim 1, further comprising causing said user profile data to be displayed on the mobile device of the first user such that the first user can consider said user profile information in deciding whether to accept the session request.

7. The method of claim 1, wherein establishing the communication session comprises:
establishing a first session leg with the mobile device of the first user through a first network;
establishing a second session leg with the communications device of the second user through a second network; and
bridging the session legs between the first user and second user to create the communication session.

8. The method of claim 7, wherein the first network is one of a PSTN network and a IP voice network.

9. The method of claim 7, wherein the second network is one of a PSTN network and an IP voice network.

10. The method of claim 1, wherein the mobile device of the first user is configured to exchange signaling and session control information with a service bridging server that establishes the communications session.

11. The method of claim 1, wherein the session request is a mobile telephone call request.

12. The method of claim 11, wherein the method is performed such that a mobile telephone number associated with the mobile device of the first user is not exposed to the second user.

13. The method of claim 1, wherein the online community is hosted by a computer system, and the method is performed by a service bridging server that communicates over a network with the computer system via API calls.

14. The method of claim 1, wherein the interface element is displayed on an online community web site in association with the profile of the second user.

15. The method of claim 1, wherein the method comprises mapping a mobile telephone number of the first user to an online community identity of the first user such that the mobile telephone number is not exposed to the second user.

16. The method of claim 1, further comprising incorporating presence and location information about the second user into the session request message before sending the session request message to the mobile device of the first user.

17. The method of claim 1, wherein the session request message comprises disposition options including at least one of accept, reject, defer, redirect, and voice mail.

18. The method of claim 1, wherein the session request includes a set of available communications modes comprising at least one of messaging, voice, instant messaging, and video.

19. A system for facilitating the establishment of voice calls between mobile device users, comprising:
a first system that hosts an online community in which users have online community identities; and
a second system that communicates with the first system to allow mobile device users that have both mobile device identities and online community identities to establish voice calls between their respective mobile devices using their respective online community identities, without exposing their respective mobile device identities to each other.

20. The system of claim 19, wherein the second system comprises a database that maps online community identities to mobile device identities.

21. The system of claim 19, wherein the second system is responsive to a request by a first user to initiate a voice call with a second user by generating a communication session request message containing online community profile information of the first user, and by sending the communication session request message to a mobile device of the second user.

22. The system of claim 21, wherein the second system obtains the online community profile information of the first user from the first system through API-based communications with the first system.

23. The system of claim 19, wherein the second system is capable of setting up a telephone call between a first user and a second user such that the first and second users are exposed to each other's online community identities but are not exposed to each other's telephone numbers.

24. A communications system comprising:
a service bridging server configured to provide service bridging functions between an application client and external service networks, wherein the service bridging server comprises:
a mapped identity database configured to store identity data for a plurality of users, the identity data comprising for each user at least one disposable identity and at least one less disposable identity;
a first interface configured to provide access to a first data network of a first type;
a second interface configured to provide to access to a second network of a second type; and
a bridging module configured to create a communications session over a communications medium having a less disposable identity associated therewith, the communications session being between a first user in communication with the bridging module via the first interface and a second user in communication with the bridging module via the second interface,
wherein the bridging module is further configured to access the mapped identity database to retrieve a disposable identity of each of the first and second user and create a network bridge between the first and second user displaying the disposable identity of the first and second users.

25. The system of claim 24, wherein the less disposable identity comprises a mobile telephone number.

26. The system of claim 25, wherein the disposable identity comprises a user ID on an online dating service.

27. The system of claim 26, wherein the communications session comprises a telephone call from the first user to the second user.

28. The system of claim 24, wherein the service bridging server is further configured to determine a communications capability for the first user and the second user.

29. The system of claim 28, wherein the service bridging server is configured to offer a mode of communication based on the determined communications capability.
